(19) United States
(12) Patent Application Publication
(10) Pub. No.: US 2012/0221603 A1
(43) Pub. Date: Aug. 30, 2012

(54) DISTRIBUTED MOBILE SERVICES

(75) Inventors: Deepak Kothule, Los Angeles, CA (US); Bagrat Mazyan, Calabasas, CA (US); Erik Forsberg, Los Angeles, CA (US)

(73) Assignee: salesforces.com, Inc., San Francisco, CA (US)

(21) Appl. No.: 13/176,612

(22) Filed: Jul. 5, 2011

Related U.S. Application Data
(60) Provisional application No. 61/361,315, filed on Jul. 2, 2010.

(51) Int. Cl. G06F 21/00; G06F 17/30

(52) U.S. Cl. 707/783; 726/29; 707/E17.005

(57) ABSTRACT

The present invention provide systems, methods, and apparatus for distributed mobile services. Methods and systems for distributed infrastructure are provided for handling mobile client requests. A distributed environment, serving the mobile community may be provided by replicating a mobile services infrastructure in more than one physical location, e.g., replicating a mobile services infrastructure for every core data infrastructure. A method is provided for handling client requests in a distributed environment, where an optimal mobile services infrastructure is discovered based on the requesting client.

### CROSS-REFERENCES TO RELATED APPLICATIONS

This application is a Nonprovisional Patent Application claiming benefit under 35 USC §119(e) of U.S. Provisional Application No. 61/361,315, by Kothule et al., entitled “Methods And Systems For Distributed Mobile Service” filed Jul. 2, 2010, the entire contents of which are herein incorporated by reference for all purposes.

The following commonly owned, co-pending United States Patents and Patent Applications, including the present application, are related to each other. Each of the other patents/applications are incorporated by reference herein in its entirety: U.S. patent application Ser. No. 12/945,410 entitled “Enterprise Level Business Information Networking For Changes In A Database” by Lee et al., filed Nov. 12, 2010 (hereinafter Lee); U.S. patent application Ser. No. 11/757,087 entitled “Method and System for Pushing Data to a Plurality of Devices in an On-Demand Service Environment” by Weissman et al., filed Jun. 1, 2007 (hereinafter Weissman), and United States Patent Application ______ [Attorney Docket No. 88262-798431] filed of even date herewith and entitled “Optimizing Data Synchronization Between Mobile Clients and Database Systems” by Kothule et al. (hereinafter Kothule I).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates generally to database systems, and more particularly to providing distributed mobile service.

Many software systems use a client-server distributed model, wherein a client requests execution of certain business operations (e.g., add a sales opportunity, view all feed items followed by a user, view forecast numbers, etc.), which leads to the request being forwarded to a server system, such as a database system, to be fulfilled. Some common client communications with backend systems (e.g., a database server) include: retrieving user data, retrieving other business data, updating data, or deleting data. Often clients interface with various middle-tier components (e.g., application servers, caching servers, business logic servers, transport or communications' layer servers, etc.) that manage client requests, sometimes forwarding the request to the appropriate underlying database or other back-end system.

Client-server systems, like other solutions, are often designed and implemented with respect to the needs of user communities at the time of the implementation. However, as technologies evolve (e.g. mobile clients are able to interact with sales type of data due to increased sophistication of mobile devices), the original solutions may not be reasonable. In particular, recent times have seen an explosion in the growth of mobile users. Original systems' infrastructure may be inadequate for such growth.

For example, the original systems may not be able to scale to support the exponentially growing mobile user base, they may not have proper fail-over capabilities, and they may not be able to provide reasonable response times. Network latencies can be caused by mobile users being located in various geographic locations around the world and requiring many communications with server components located in a geographic location at a substantial distance from the mobile client.

Therefore it is desirable to provide systems and methods that overcome the above and other problems.

### BRIEF SUMMARY

Embodiments of the present invention provide systems, methods, and apparatus for distributed mobile services. In various embodiments, methods and systems for distributed infrastructure are provided for handling mobile client requests. In one embodiment, a distributed environment, serving the mobile community is provided by replicating a mobile services infrastructure instance in more than one physical location. In one aspect, the replicated mobile services infrastructure is co-located in every core data infrastructure, maintaining the underlying business data for users. Some advantageous of maintaining a distributed environment is better response and up times for users of such services.

According to one embodiment, a method of handling client requests in a distributed environment is provided. A first mobile service instance receives a client request. The first mobile service is one of a plurality of mobile service instances. The first mobile service instance then determines an optimal mobile service instance to handle the client request based on information about the requesting client.

In one aspect, where the first mobile service instance is the same as the optimal mobile service instance, the requesting client is authenticated using the first mobile service instance and a message is sent to the client with the results of the authentication. In another aspect, where the first mobile service instance is not the same as the optimal mobile service instance, the requesting client is directed to the optimal mobile service instance (e.g., by providing the URL for the optimal mobile service instance). In a further aspect, the client can also provide an error code and/or error description.

In one implementation, the requesting client, after receiving information about the optimal mobile service instance, submits a client request to the optimal mobile service instance. In one case, the client request to the optimal mobile service instance is the same request as the original client request to the first mobile service instance. In another case, the client request to the optimal mobile service instance is a different, second client request. Once the optimal mobile service instance processes the client request, its results are sent to the requesting client. In another embodiment, the re-directing to the optimal mobile service instance is done automatically, without client intervention. In one implementation, the automation may be achieved by performing the redirect on behalf of the user.

In one embodiment, the optimal mobile service instance for the requesting client is persisted for subsequent client requests from the requesting client. In another embodiment, when requests from a client are received by a first mobile services instance, the instance will check to see if information about an optimal mobile service instance exists. In one aspect, if information about an optimal mobile services instance exists and where the optimal instance is not the same as the first mobile service instance, the requesting client will be re-directed to the persisted optimal mobile service instance. In another aspect, where information about an optimal mobile services instance does not exist, an optimal mobile service instance will be first determined by the processing first mobile instance to process the client's request.

According to another embodiment, an optimal mobile service instance information is sent to one or more clients. In one aspect, this information is sent as an advisory message, containing information, e.g., an error message and/or a redirect URL about the optimal mobile instance, without first receiving a client registration request. The advisory message may be used to support dynamic migration. In one case, after receiving an advisory message, a client may initiate a request to utilize the optimal instance for future communications or requests.

While the present invention is described with reference to an embodiment in which techniques for performing searches of feeds in an on-demand enterprise services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an example of an environment wherein an on-demand database service might be used.

FIG. 2 illustrates a block diagram of an embodiment of elements of FIG. 1 and various possible interconnections between these elements.

FIG. 3 illustrates a block diagram of components of a mobile services environment according to embodiments of the present invention.

FIG. 4 illustrates a block diagram of components of a mobile services infrastructure and a core data infrastructure according to embodiments of the present invention.

FIG. 5 illustrates a distributed environment according to various embodiments of the present invention.

FIG. 6 illustrates a distributed environment, showing both a registration MSI instance and a redirected optimal MSI instance, from a plurality of MSI environments.

FIG. 7 is a flowchart illustrating a method of handling a client request in a distributed environment according to embodiments of the present invention.

FIG. 8 is a flowchart illustrating a method of handling a client request, subsequent to an initial registration request, in a distributed environment according to embodiments of the present invention.

### DETAILED DESCRIPTION

### I. General Overview

Systems and methods are provided for distributed mobile services. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Mechanisms and methods for providing systems and methods for optimization techniques for accessing business data will be described with reference to example embodiments. First, a systems overview is provided illustrating an environment where an on-demand database service might be used. It is followed by a section on distributed mobile services with various subsections. Section A, mobile services and core data infrastructure environment, illustrates an environment that can serve mobile client requests. Section B, distributed mobile services environment, describes various distributed mobile services environments.

Section C, discovery of an optimal distributed mobile services, describes how an optimal distributed mobile service instance can be determined and how client requests can be handled. Section D, mobile administration console, describes a console used for managing mobile clients. Section E, client disaster recovery/organization migration, describes how a distributed environment can be used to handle disaster recovery and organization migration scenarios. Section F, device registration error codes, provides some details on error codes. And Section G, instance migration, describes how a distributed environment can be used to migrate users from one instance to another.

### II. System Overview

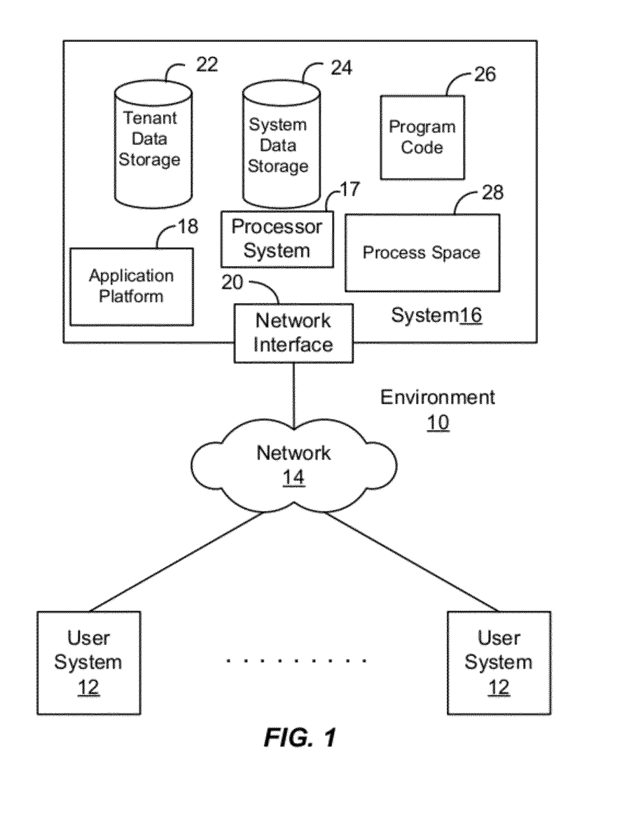

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

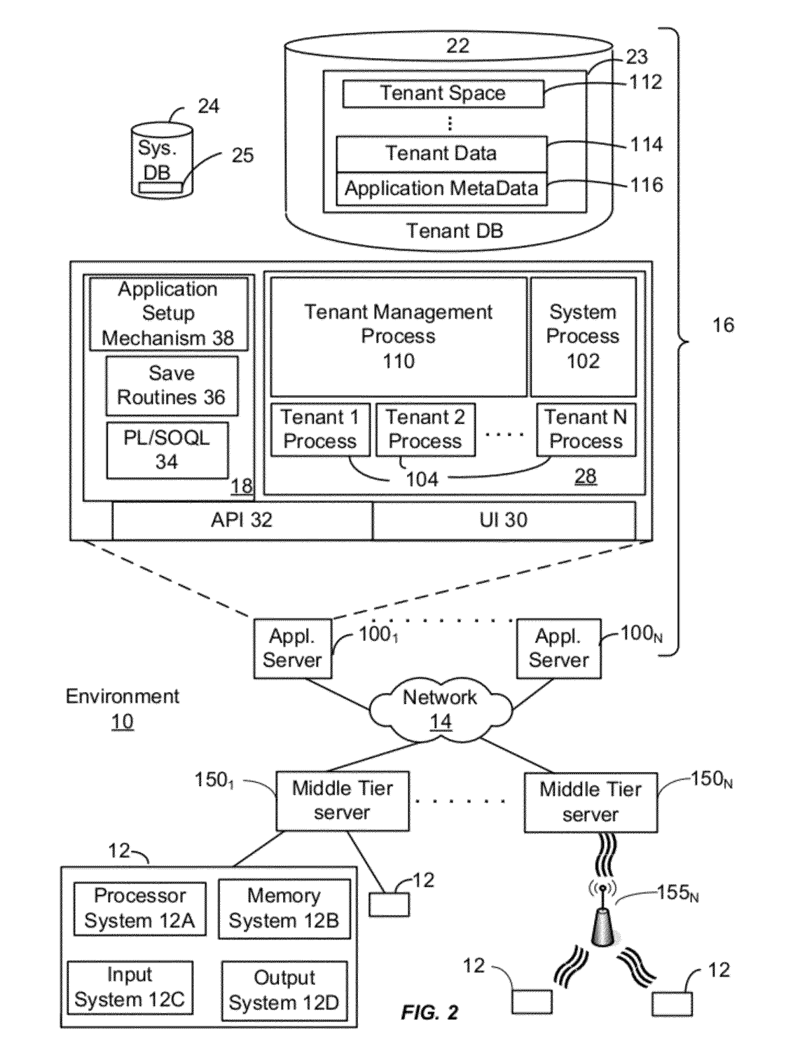

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications as well as provide related data, code, forms, webpages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide webpages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 illustrates a block diagram of an embodiment of elements and various possible interconnections between these elements. In the embodiment illustrated by FIG. 2, one or more middle tier servers 150 exist between system 16 and user systems 12. Middle tier servers 150 are termed middle tier because these servers are interposed between the system 16 and the user systems of a particular organization. As described above, network 14 may be used for communication between system 16 and system 12. In one embodiment, the same network 14 is used between a middle tier servers 150 and user systems 12. In another embodiment, a different network is used between a middle tier server 150 and user systems 12. For example, a tenant network 155_{N} may be a wireless network, and network 14 may provide communicable coupling via fiber-optics. Each network 14 or tenant network 155_{N} may also be a combination of different types and protocols.

In one embodiment, each middle tier server 150 manages data of a different organization or tenant, however other embodiments may include information of more than one tenant coupled to a single middle tier server. In another embodiment, each middle tier server 150 may contain a plurality of servers, which collectively provide communication between system 16 and user systems 12 of an organization. The tenant network 155 of each organization may be of a different type (e.g. wireless, optical, . . . ) or protocol. Examples of wireless protocols include Wireless LAN, Global System for Mobile Communications (GSM), Personal Communications Service (PCS), D-AMPS, Wi-Fi, General Packet Radio Service (GPRS), 3G wireless systems such as those using Code division multiple access (CDMA), HIgh PErformance Radio LAN (HIPERLAN), and Worldwide Interoperability for Microwave Access (WiMAX).

Additionally, FIG. 2 further illustrates elements of system 16 and various interconnections. FIG. 2 shows that user system 12 may include processor system 12A, memory system 12B, input system 12C, and output system 12D. As shown in FIG. 2, network 14 couples user systems 12 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) and/or middle tier servers 150 communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### III. Distributed Mobile Services

Users of database system 16 or system 22 of FIG. 2 often require communicating with database system 16 or system 22, which stores data of interest to the user. Such communications are often bi-directional; so user updates on the client machine can be forwarded to the database for storing and updates on a database system (e.g. updates by other users, by the current user at another time, or other systems, etc.) or other user data may need to be communicated back to the client machine. Users 12 of FIG. 1, that use the systems described in FIG. 2 may be mobile users. Users may request services from various systems and/or sub-components to fulfill their business needs.

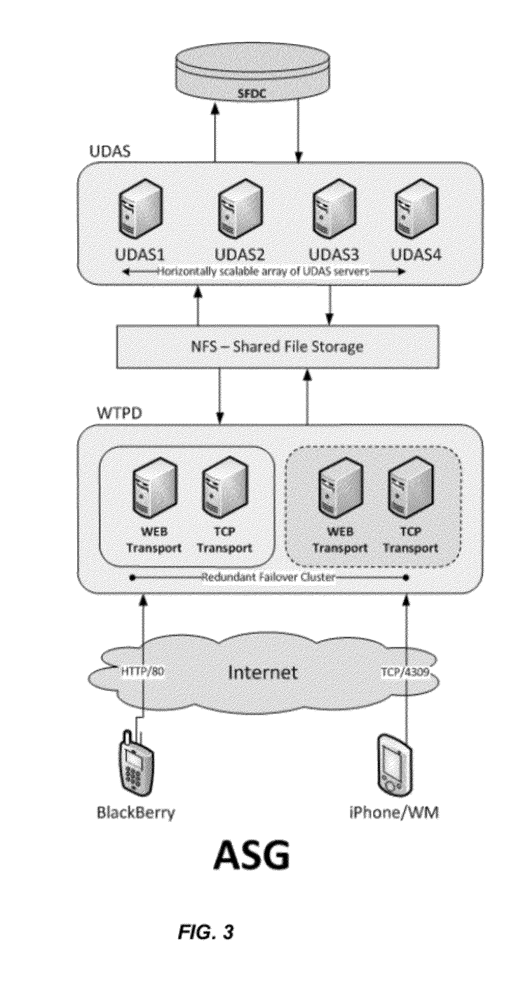

FIG. 3 illustrates a block diagram of components of a mobile services environment according to embodiments of the present invention. It shows Blackberry and iPhone mobile clients, using the HTTP and TCP/IP protocols respectively, to ultimately communicate with a database system (i.e., SFDC in FIG. 3). The mobile clients may use various middle-tier components, wireless transport protocol daemon—WTPD, network file storage—NFS, and universal data access server—UDAS to communicate with SFDC databases. WTPD may serve as a transport layer, accepting mobile clients using various protocols (e.g., HTTP, TCP/IP, etc.). NFS may serve as a queuing component, saving both inbound and outbound messages for further processing. And UDAS may serve as the data logic layer that facilitates communications between mobile clients and the underlying business data server SFDC.

A. Mobile Services and Core Data Infrastructure Environment Overview

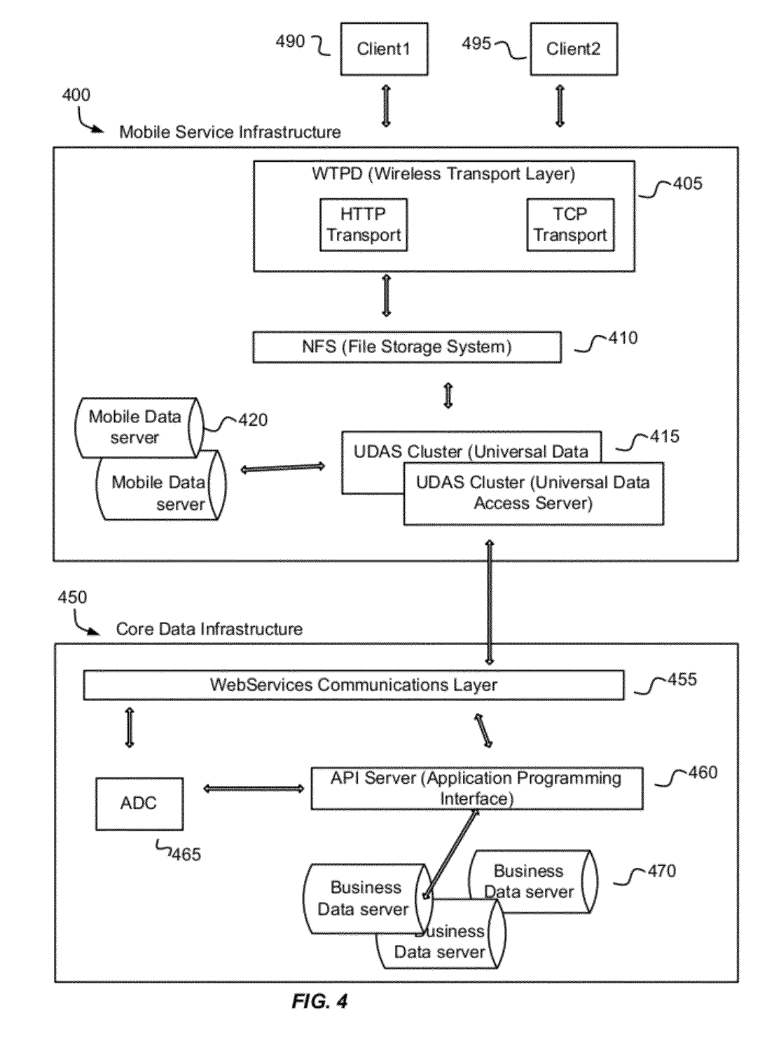

FIG. 4 illustrates a server environment that can service a mobile user community, e.g., to retrieve and update bi-directionally user data. Mobile client 490 represents a mobile user communicating via HTTP protocol, while mobile client 495 represents a user communicating via TCP/IP protocol. In other embodiments, other protocols may be used. Often mobile clients 490 and 495 are interested in communicating with the business data servers 470 of the core data infrastructure environment 450, in order to either update or retrieve data from the business data servers (bDS) 470. Mobile clients may need to go through various middle-tier components in order to ultimately communicate with the underlying bDS 470 (i.e., they may need to communicate with various middle-tier components of mobile services infrastructure before the bDS).

FIG. 4 shows two server environments 400 and 450 used by mobile clients 490 and 495. The first environment is shown as a mobile services infrastructure (MSI) 400, which can act as middle-tier components. The sub-components of MSI 400 can include web transport layer (WTPD) 405, network file storage system (NFS) 410, universal data access server (UDAS) 415, and mobile data server (mDS) 420. The second environment is shown as a core data infrastructure (CDI) 450. The sub-components of CDI can include web services communication layer (WSC) 455, application programming interface server (API server) 460, application data cache (ADC) 465, and business data server (bDS) 470. bDS 470 may, for example, correspond to database 22 as described in FIG. 2, which can stores a user's business and other data.

Mobile client 490 and 495 communicate with WTPD 405 making requests, bi-directionally (e.g. providing updates to bDS 470 and retrieving data of interest from bDS 470 and/or ADC 465). WTPD 405 may serve as a communications protocol manager that handles requests of various types (e.g., HTTP requests from client 490 and TCPI/IP requests from client 495) and standardizes those varying protocols' requests into a common format, e.g., as could be understood by UDAS 415. HTTP and TCP/IP client types have been represented in FIG. 4, however MSI 400 may handle requests of other mobile protocols (e.g. WAP, etc.).

The WTPD-standardized requests may then be stored in an NFS 410 system to be retrieved and serviced by UDAS 415. Also, results of a request executed by UDAS 415 may be stored in NFS 410 to be delivered to the requesting mobile clients 490 or 495. NFS 410 may serve as a queuing layer, which queues inbound requests from WTPD 405 for UDAS 415 to pick up and service. NFS 405 also may queue outbound communications, results of a request, to be communicated back to requesting clients 490 and 495. One advantage of queuing all inbound and outbound communications may be to allow the components processing such events or results or messages to process them when their system resources permit. For example, UDAS 415 may read or de-queue from NFS 410 client requests awaiting processing when the UDAS 415 cluster is able to. Similarly, WTPD 405 may read outbound data and/or other messages to deliver to a client when the WTPD servers have resources free. Another advantage of NFS 405 is for fault-tolerance (i.e., messages can remain queued in the NFS 410 layer until such time as a component is able to process the message).

UDAS 415 may take one or more requests from NFS 410 that are awaiting processing from, e.g., the CDI 450 environment. UDAS 415 may take a request and forward it to bDS 470, sometimes using intermediary components such as WSC 455 and/or using API server 460. Upon completion of a request by bDS 470, UDAS 415 may then communicate the information back to WSC 455 to provide to UDAS 415. UDAS 415 may write outbound data and/or messages to NFS 410 for delivery to the requesting client by WTPD 405, when resources are free.

UDAS 415 may serve as a communications layer for data access for the mobile user community. It may take requests queued on NFS 410 and convert them into a format understood by the CDI environment 450, in particular converting the requests into a format understood by the WSC 455 layer. UDAS 415 may also provide additional business functionality, such as caching mobile users' data and/or manipulating data retrieved on behalf of the user. UDAS 415 may also communicate with ADC 465 or other server components in order to service a client request.

An MSI environment may contain an mDS database 420. An mDS 420 may contain configuration information needed by a specific MSI instance. For example, it may contain information about mappings between registered and activated devices and corresponding user information. Some user information may be the corresponding data synchronization state for a user (i.e., information about the latest data that a device has, possibly based on previous synchronizations). Maintaining information about the data synchronization state for a device can help later optimize information sent to a requesting client device. For example, only data that is newer (e.g., delta changes), based on the data synchronization state for a device, needs to be forwarded back to a client for synchronization purposes. Accordingly, a UDAS 415 may use an mDS 420 to determine what data to forward to a requesting client. A UDAS 415 may also update client device or user information stored in an mDS 420. For example, UDAS 415 may update data synchronization information in an mDS 420 after forwarding data to a client device, thereby helping maintain the latest data information for a device.

Components described in FIG. 4 illustrate one embodiment of how mobile clients' requests can be handled by various system components. Other solutions providing capabilities to service mobile clients may exist without deviating from the spirit and scope of the present disclosure. The components of FIG. 4 may exist on a single computer or on a host of machines. One computer may be used for one or more components. The machines may be configured with various operating systems. The components may be installed in a scalable, reliable and fault-tolerant way. The scalability and fault-tolerance may be implemented by the component and/or using external solutions.

Some exemplary components are described but other components may also play a role in servicing the mobile user base. One component may be separate code or may share code amongst other code/software. Components may run various types of software, written in a host of programming languages. Database systems, bDS 470 and mDS 420 may implement any database system that facilitates the storing, updating, retrieval of data that clients 490 and 495 may be interested in.

B. Distributed Mobile Services Environment

Mobile services infrastructure (MSI) may exist in locations different from the core data infrastructure (CDI). For example, an MSI server environment may exist in one location (Location1) while the CDI server infrastructure may exist in multiple geographic locations (Location1, Location2, Location3, Location4, and Location5). CDI environment may have capability of failover to a backup data center (i.e., to Location1) and vice-e-versa. Within an environment, the services can be scalable and redundant by using, e.g., the inherently horizontal scalability at the mobile server level (many UDAS instances) and a Solaris Cluster (failover) implementation of a mobile transport server WTPD.

In a systems environment such as described above, where most of the core data capabilities are based in a location, separate from the mobile services infrastructure, there can be dependencies upon connectivity between the two environments. There can be networking outages due to various issues. Also, there can be various network latencies, e.g., sometimes the mobile client sitting in Location5 has to make several trips between the mobile severs in Location1 and the core data servers located in Location5 locally. The network latencies can be compounded due to multiple round-trip communications between an MSI and CDI environment, required for fulfilling a client request (e.g., in order to register a client, a UDAS may have to communicate with a database residing in a CDI environment 3 times, once for retrieving login information, another time for retrieving user profile information, and a third time to retrieve user synchronization data). The network communications overhead can be especially problematic where the distances between Location1 and Location5 are great.

As mobile use continues to grow (e.g., some counts are near about 75,000 simultaneously connected devices), and mobile users are in many non-US countries, it can be desirable to have each mobile device be able to connect to an optimal mobile services data center (e.g. nearest available data center, the most resource free available data center, etc.) instead of a single mobile services infrastructure data center, to avoid excessive network latencies and other problems. Accordingly, it can be advantageous to provide a distributed mobile services infrastructure where users may connect to different instances for optimal user experience. Different instances may be provided by setting up a distributed mobile services infrastructure. For scalability and performance, some embodiments may have more than one mobile server instance in any one data center or geographic location. In a disaster scenario like the loss of a data center, there may still be mobile services available for the un-affected users in a distributed environment.

Accordingly, in some embodiments improved methods and systems are provided for distributed mobile services. In one embodiment, mobile services infrastructure environment (as illustrated as MSI in FIG. 4), is replicated in every core data infrastructure (as illustrated as CDI in FIG. 4) environment location. For example, each of the above discussed CDI locations (Location1, Location2, Location3, Location4, Location5) may also deploy a set of MSI components, perhaps running on a set of MSI servers. Therefore, each CDI environment may maintain coupled to it a corresponding MSI environment, with a set of UDAS servers and a transport WTPD cluster, perhaps giving each MSI instance a specific name of tpN.mobile.vendor.com (where N is a decimal number, representing the location of an instance). In one aspect, a certificate (e.g. an SSL certificate) may be used for communicating with each WTPD transport instance. In other embodiments, only some of the components described in FIG. 4 may be replicated in an infrastructure environment location.

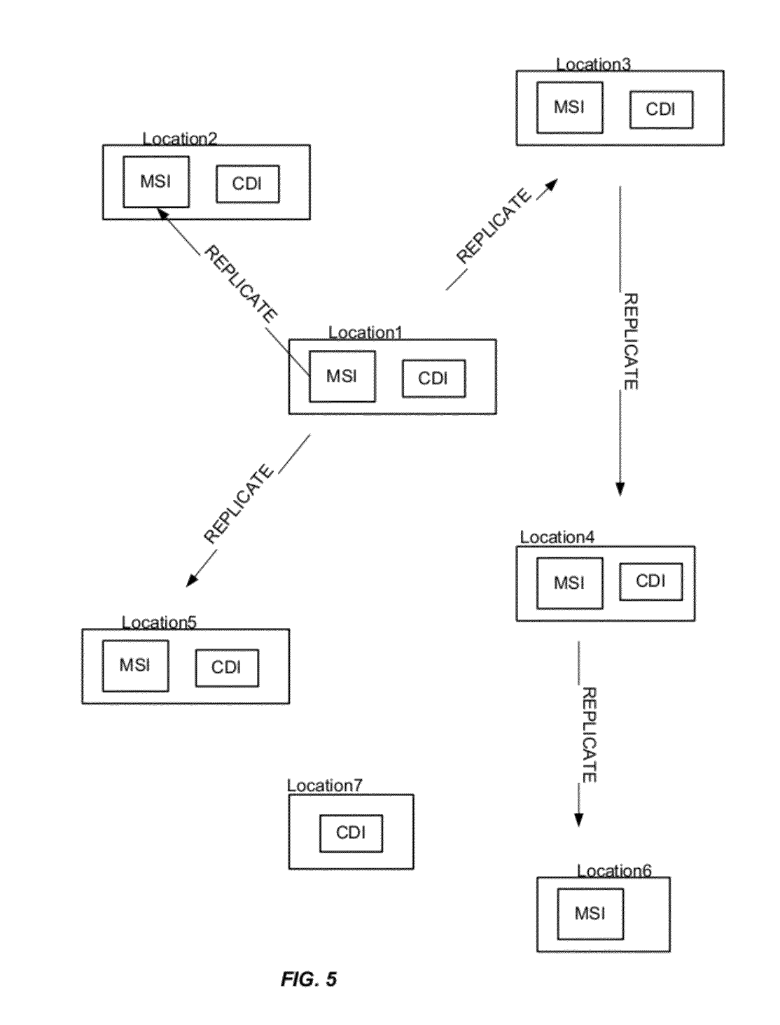

FIG. 5 illustrates a distributed environment according to various embodiments of the present invention. FIG. 5 shows various locations (Location1, Location2, Location3, Location4, Location5, Location6, Location7) maintaining an MSI environment and/or a CDI environment. Location1 has both an MSI environment and a CDI environment. The figure depicts the replication of Location1's MSI environment to Location2, Location3, Location4, and Location5. In one aspect an MSI environment may be replicated from Location1, while in other aspects a location's MSI environment may be replicated from any other location with an MSI environment. Replicating an environment does not require every component and/or data from one environment to be reproduced.

One advantage of coupling each core data infrastructure with a mobile services infrastructure, in the same geographic and/or physical location may be to avoid network latencies required due to a host of communications between the MSI and CDI components, done to fulfill client requests. Other advantages, can be removing inter-datacenter connectivity dependencies, more graceful handling of disaster recovery, organizational migration, and instance migrations. In other embodiments, the MSI environments may not be replicated in every CDI environment location, rather they may be strategically replicated in more than one geographic and/or physical location to manage mobile traffic in an efficient and reliable manner.

In various embodiments, other schemes, other than replicating one MSI environment in every CDI environment location, may be used to distribute a mobile services infrastructure. Other schemes may be employed because it may be too costly or unnecessary (i.e., no performance benefit to a mobile user) to replicate an MSI environment in every CDI environment location. Accordingly, in one embodiment MSI environments may be replicated in one or more CDI locations, but not in every CDI location (e.g., FIG. 5 shows Location7 that maintains a CDI environment where no MSI environment has been replicated, it may use the MSI environment from another location such as Location5.). Such a deployment may be efficient, e.g., where two CDI environments are located relatively close to each other and therefore can be serviced by one MSI environment hosted near both CDI environments.

In another embodiment, it may be advantageous to replicate MSI environments in more locations that CDI environments. For example, MSI environments may exist in N+X locations, where N is the number of CDI environment locations and X is the number of MSI environment locations above the number of CDI locations. Maintaining more MSI environments than CDI environments may be efficient, e.g., where the MSI environment traffic has become a bottleneck for a CDI data center location (e.g., FIG. 5 shows Location6 maintaining only an MSI environment, it may use the CDI environment from another location such as Location4).

C. Discovery of an Optimal Distributed Mobile Services and Handling Client Requests in a Distributed Environment

In various embodiments, for the mobile area, an optimal (e.g. nearest, fastest, etc.) mobile server infrastructure instance (MSI instance) may be discovered during an initial mobile device registration and/or authentication process. In another aspect, an optimal MSI instance may be discovered using an explicit discover optimal MSI instance request. In one embodiment, a mobile device may be assigned to an optimal MSI instance that exists in the same core data center CDI as the regular (non-mobile) instance itself. For example, users assigned to a North America instance one (NA1) could be assigned to an optimal MSI instance that is co-located with the NA1 instance. This can minimize the network latencies related to the API traffic and could also simplify routing and have no dependency on inter-datacenter connectivity which may increase overall reliability.

According to another embodiment, an optimal mobile service instance information is discovered and sent to one or more clients, without first receiving an initial mobile device registration request. In one implementation, the optimal instance information may be discovered when a client sends a full data synchronization request (e.g, full=1 option)(e.g., from UDAS 415 of FIG. 4). The UDAS 415, upon receiving a full synchronization request, may check to see if the requesting client is communicating with an optimal mobile services instance. If yes, then nothing may be done. If no, then an advisory message, containing information, e.g., an error message and/or a redirect URL about the optimal mobile instance may be sent indicating to the client to consider re-registering with the discovered optimal instance. In one case, the advisory message may be used to support dynamic migration (e.g., to new MSI instances). After receiving an advisory message, a client may initiate a request to utilize the optimal instance for future communications or requests. On the other hand, the system may automatically re-register the client with the discovered optimal instance.

In one embodiment, there is a default registration transport instance (e.g., FIG. 5's tp.mobile.vendor.com) that can be used by a mobile client for discovering a mobile instance that is optimal for the client. In one aspect, the default transport registration instance can be a virtual IP address that can map the URL of the default instance to one of many transport instances to avoid the name itself being a single-point of failure. The VIP mapping may be done after a significant number of clients have been updated to support the new distributed model.

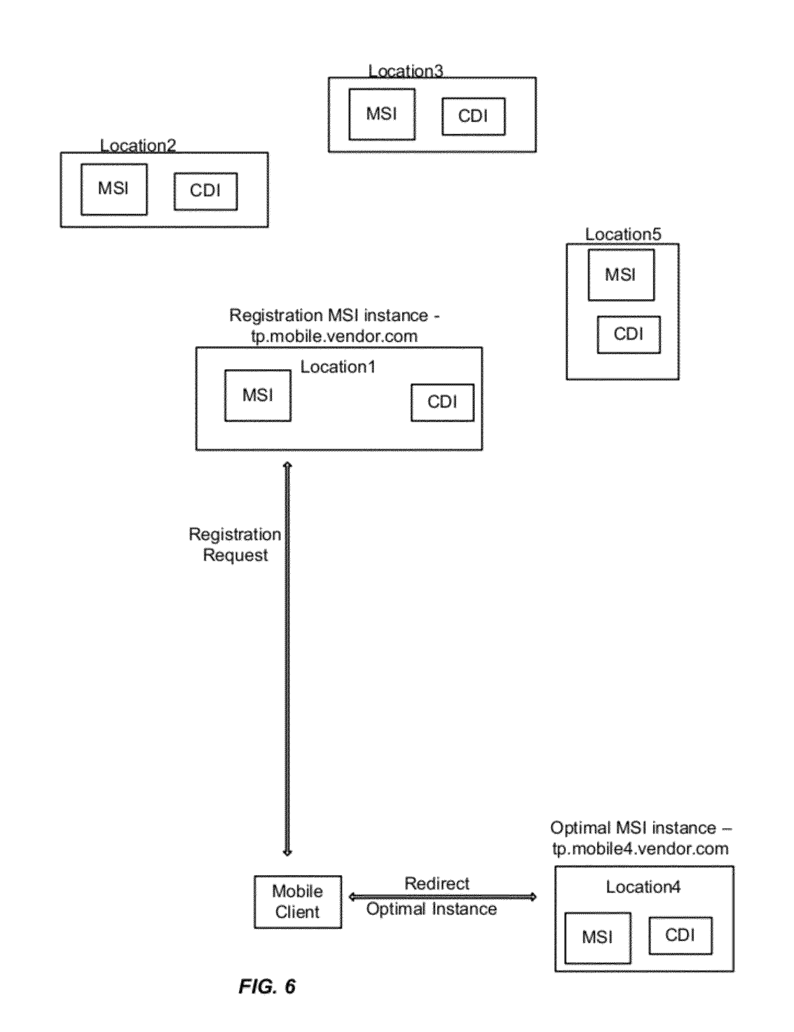

FIG. 6 illustrates a distributed environment, showing both a registration MSI instance and a redirected optimal MSI instance, in a plurality of MSI environments. A mobile client communicates with a registration MSI instance, tp.mobile.vendor.com that then redirects the mobile client to another MSI instance that is optimal for the mobile client. The optimal MSI instance depicted is tp.mobile4.vendor.com. FIG. 6 illustrates that the optimal MSI instance is the location closest to the mobile client, shown by the mobile client being physically closest in the diagram to Location4 or tp.mobile4.vendor.com.

In one embodiment, an MSI registration instance (i.e., the MSI environment servicing an initial mobile device registration and/or authentication request) that performs the device registration will authenticate against a core data center instance (CDI instance). During the authentication, the system can discover which MSI instance is optimal for the user. In one aspect, the CDI instance is co-located in the same data center as the registration MSI instance (e.g., FIG. 6 the CDI instance co-located in the box representing tp.mobile.vendor.com—the location processing the registration request). In one embodiment, the CDI or MSI instance assigned to a user's organization (e.g., maybe as a field or attribute of a database table or some other data object) may help identify the optimal MSI instance for the requesting client. An optimal MSI instance may be assigned based on various other user attributes as well (e.g., location of user, etc.).

The system may then check if the optimal instance is the same MSI instance as the processing MSI instance (i.e., the MSI registration instance from which the client made the initial mobile device registration request). If it is the same MSI or CDI instance as the processing instance, then the processing system can proceed with the device registration, authentication, thereby completing the client request. If it is not the same (e.g., as is depicted in FIG. 5 where the registration instance is tp.mobile.vendor.com, while the optimal MSI instance is tp.mobile4.vendor.com), the system may send a specific device registration error to the clients, with an error code and/or a new URL that gives the client the location of the optimal MSI instance which the client should use. The client can retry the device registration on the provided instance, which is then expected to be successful.

In some cases, when a client receives a redirect URL and/or an error code, e.g., to the optimal MSI instance, the client may overwrite its stored copy of the transport instance to be used for future/subsequent client requests. In one embodiment, a client can recognize being redirected twice and treat that as a fatal error as it would be the symptom of a mal-functioning mobile server infrastructure. In one embodiment, one of a plurality of MSI instances may serve as an initial user registration MSI instance.

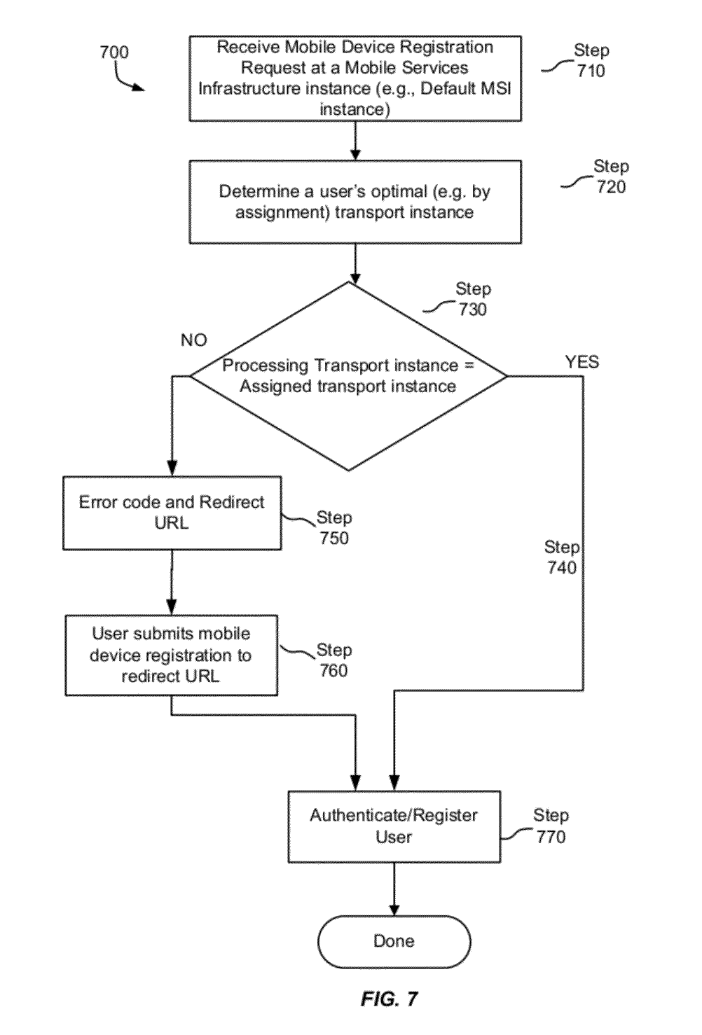

FIG. 7 is a flowchart illustrating a method 600 for finding an optimal MSI instance for a user. At step 710 a mobile user sends an initial mobile user registration request to a registration MSI transport instance. In one aspect, the registration instance may be a global default MSI instance (e.g. an MSI instance to be used for first time registration, such as a URL tied to a particular default MSI services instance such as tp.mobile.vendor.com). In another aspect, the registration MSI instance may be the last MSI instance assigned to the requesting user (e.g., one of tp.mobileN.vendor.com). In yet other aspects, the registration MSI instance may be selected based in some other reasonable manner (e.g., users from Asia go to a particular default registration instance, while users in North America go to another default registration instance). The MSI instance may contain the server components illustrated in FIG. 4 and such components may be used to register a mobile client.

At step 720, the registration MSI instance may communicate with a CDI environment, which may be coupled to it (i.e., in the same server location), to determine what MSI instance is optimal for the mobile user. In one aspect, the optimal instance can be determined by querying the bDS database (as described in FIG. 4) of the CDI environment to determine the mobile user's organization and corresponding optimal MSI instance. In other aspects, a user's optimal MSI instance may be determined by other user criteria (e.g., location of the user, the state—up or down—of various MSI and/or CDI environments, etc.).

Once a user's optimal MSI instance is determined, step 730 can check to see if the current processing MSI instance (i.e., the registration MSI instance that is processing the registration request) (e.g., the default MSI instance) is the same as the determined optimal instance. If the optimal instance is the same as the currently processing instance, then at step 740 the requesting user will proceed to authentication and registration at step 770, may be using the coupled CDI environment.

In the case where the processing MSI instance is not the same as the determined optimal MSI instance at step 730, the user may be supplied with a URL and/or error code for redirection to the optimal MSI instance for the user to complete registration with, at step 750. In one case, the user can then use the supplied information to complete registration with the newly provided optimal MSI instance at step 760. Finally, at step 770 the user will be authenticated by the optimal MSI instance, using perhaps the CDI environment coupled to it.

In one aspect, the determined optimal MSI instance information can be persisted for future requests from the requesting mobile client (e.g., by overwriting a data object storing a user's MSI instance information). The persistence can be in any reasonably accessible object, e.g., a file or data object on the client device or some other easily accessible data object location for the mobile client. An advantage will be that for subsequent communications the user can skip the discovery steps described in FIG. 7 and go directly to authentication at step 770, using the MSI instance information in the persisted location.

In one aspect, a device registration retry (as described in step 760 of FIG. 7) can be an inconvenience to users, particularly for those users that have setup custom authentication schemes using one-time passwords. Accordingly, one embodiment can have the mobile services use a private API call, specifically for discovering an optimal MSI instance. For example, the private API may be an un-authenticated API that can be used to ask the API which instance a specified user belongs to. In one embodiment, the feature can be used to detect current location (and discover organizations that have been moved).

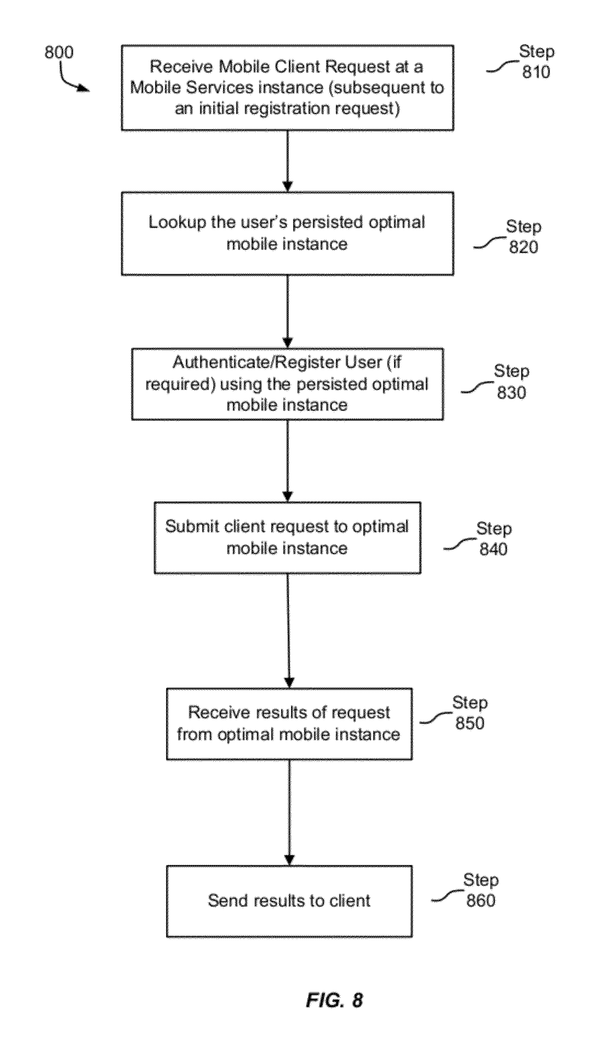

FIG. 8 is a flowchart illustrating a method for handling mobile client requests, e.g., subsequent to an initial user registration request as described for FIG. 7. In some embodiments, subsequent user requests may follow the steps of FIG. 8. At step 810, a client request is received, subsequent to initial client registration request at a MSI instance the mobile client is communicating with. At step 820, the processing MSI instance may retrieve the previously determined and persisted optimal mobile services instance (MSI) from a data object persisting such information. The retrieved persisted MSI instance then may be used to authenticate the user at step 830. Step 830 may not be performed when authentication is not desired. Then the client request may be forwarded to the retrieved optimal instance at step 840. And upon the optimal instance receiving the results at step 650, they can be sent to the requesting client at step 860.

In one embodiment, a mobile client option bit may be used by clients to declare that they support a distributed mode of mobile transport service. Existing clients can be supported as is, and may continue to be associated with a default mobile transport (e.g. the MSI instance located in Location1, with the URL of tp.mobile.vendor.com). In one implementation, mobile clients that support the distributed mode (e.g. those with mobile client option bit) of operation may send this client option in every protocol message, including device registration, device update, and un-register messages.

When a new client performs a mobile device registration request indicating support for the new distributed mode, the registration request can be sent to any known transport instance. For an initial registration, the default registration transport (e.g. the MSI instance located in Location1, with the URL of tp.mobile.vendor.com) instance could be used. For a re-registration, the client could use the instance it was last assigned to, as that is likely to be the one to be used by the client again.

In one embodiment, mobile clients may be provided with a read/only view of which MSI transport instance is being used to handle their communications. In another embodiment, a mobile client may be able to update the instance.

D. Mobile Administration Console.

In some embodiments, a mobile administration console (MAC) is provided for managing various information about mobile users. In one embodiment, a mobile device data object may be updated with one or more additional column/attribute which will contain the assigned optimal MSI transport instance hostname (i.e., upon the discovery of an optimal MSI instance as described in FIG. 7). The column may be written by the mobile server during the device registration process. The column may later be used for subsequent user queries (as described in FIG. 8). In some cases, when an administrator uses the mobile administrator console page (or at other times), the value of such a column can be displayed. In one implementation, the value cannot be changed from the console. In another embodiment, an administrator may be able to update the value of an optimal MSI transport instance via the administration console.

In another embodiment, when a mobile administrator console (MAC) performs mobile device related management functions, using for example an RPC protocol on port 4300, the MAC may connect to a remote services management agent daemon (RSMAD) instance that is in the same instance as the transport instance. A MAC may be used to set up synchronization configurations (e.g., sets of objects to be made available to mobile users and filters to be used to synchronize records for mobile devices). MAC may also be used by administrators to specify various settings for create, delete, or updates from and/or to mobile devices. MAC may also be used to assign users to specific synchronization configurations, for mobile device management, and other mobile related actions. In one aspect, if a MAC connects to the wrong transport instance or operates on some old stale data, a client may get an error message.

E. Client Disaster Recovery/Organization Migration.

In one embodiment, if an MSI transport instance fails, then a decision may be made to take it out of service. In one aspect, the failed instance should only be taken out of service if the instance is expected to be out of service for a significant amount of time. In such a case, according to one aspect, user requests to the failed instance can be handled by redirecting the instance name to another instance that will simply return the mobile transport error code that de-activates the device and forces users to re-register. Upon re-registration, the device can be redirected to a functioning transport instance (as described in FIG. 7 steps 750 and 760). Re-registration can be used in order to reliably re-create state held in the transport instance.

In another embodiment, embodiments of the distributed mobile services architecture also allow a disaster recovery (DR) scenario where both the database and file systems states are mirrored against a standby instance in another data center. In one aspect, some inconsistencies can be expected if ever switched to standby DR node. Networking bandwidth between DR nodes can be carefully considered. For example, as of today there are peak disk write rates up to 50 MB/second on production and this is expected to grow.

Due to the difficulties in perfection of the above, some embodiments can take advantage of the ease of re-establishing state with the help of clients. Some embodiments can reduce the effects on the mobile user, particularly to avoid a need to re-register (re-authenticate) the device because the authorization token is still present and should be usable. In one embodiment, to accomplish this, a new client state can be introduced and can work as outlined as follows.

In one embodiment, when a client sends a message to a server, server will perform an authorization (e.g. using open authorization, OAuth) of the login and discover that the transport instance has been changed (due to the failed instance). In the case that the client supports the distributed protocol (client option), the system can return a specific error code, sometimes indicating that an organization migration has occurred, and the new location of the transport instance server. In the case where a client does not support the distributed protocol, the system could keep working as is using the existing transport instance. In one embodiment, to avoid all devices in an organization to migrate all at the same time, the system can only perform the check when we receive a run (full=1) message from the client, which can spread out the migrations but still happen typically within 24 hours.

When client receives such error, it can reset its current state, display a page to the user giving feedback at to what is happening. The client can then perform the following steps to re-establish state and synchronization.

In one embodiment, a client can send a register message but use OAuth token for authentication instead of a core data server username/password. This can tell mobile server that user already has been registered in the organization and there is no need to request a token, requiring only the update of existing mobile device record and create needed job records in a application exchange mobile database. After successful registration, client can send an activation message which will re-establish data synchronization between all parties.

F. Device Registration Error Codes.

In one embodiment, upon device registration (or device update) from a mobile client that do indicate support of the distributed mode by its client options, may receive an error code. The error can indicate that the client shall look for the field redirect in the response and use its value as the mobile transport instance to be used from that point. The device registration can be retried on that instance automatically.

G. Instance Migration

In one embodiment, an optimal instance discovery may be used for environment migration. For example, when a device sends a run message with an option to indicate full synchronization of data (e.g., using a full=1 option) (i.e., provide a full set of data updates and not just delta changes from a previous update), which typically happens every 24 hours, and the client supports the distributed mode as indicated in the client options, the system can check if there has been a change in the assigned optimal transport instance. If there has been a change, the run message may not be processed and instead may be completed with a redirect URL to the changed instance and/or an error code. In one implementation, the client can use this embodiment, providing a changed transport instance, to perform the orderly migration actions as outlined in the Client disaster Recovery/Organization migration section above.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

It should be understood that the present invention as described above can be implemented in the form of control logic using hardware and/or using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive, a CD, or an entire computer system), and may be present on or within different computer program products within a system or network. A computer system may include a monitor, printer, or other suitable display for providing any of the results mentioned herein to a user.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. A method of handling client requests in a distributed environment, the method comprising:
a first mobile service infrastructure receiving a first data access request from a first mobile client, wherein the first mobile service infrastructure is one of a plurality of mobile service infrastructures, wherein a mobile service infrastructure is configured to provide communications between a mobile client and a database; and
the first mobile service infrastructure determining an optimal mobile service infrastructure to handle the first data access request based on the requesting client, wherein the optimal mobile service infrastructure is one of the plurality of mobile service infrastructures.

2. The method of claim 1, wherein the first access request is an initial device registration request.

3. The method of claim 1, wherein the plurality of mobile services infrastructures are not identical to each other, wherein not identical means the plurality of infrastructures have differing hardware or software components amongst the plurality of infrastructures.

4. The method of claim 1, wherein the first mobile service infrastructure is the optimal mobile service infrastructure, the method further comprising:
authenticating the client using the first mobile service infrastructure; and
sending a message to the client based on the results of the authentication.

5. The method of claim 1, wherein the first mobile service infrastructure is not the same as the optimal mobile service infrastructure, the method further comprising:
directing the client to the optimal mobile service infrastructure;
the optimal mobile service infrastructure receiving a second access request;
the optimal mobile service infrastructure processing the second access request; and
sending the results of processing the request to the requesting client.

6. The method of claim 5, wherein the directing of the client to the optimal mobile service infrastructure is accomplished by sending a redirect Universe Resource Locater (URL) to the requesting client, wherein the redirect URL points to the optimal mobile service infrastructure.

7. The method of claim 5, wherein the second access request is the first access request.

8. The method of claim 1, further comprising:
persisting information for connecting to the determined optimal mobile service infrastructure.

9. The method of claim 8, further comprising:
receiving a second client request;
looking up the persisted optimal mobile service infrastructure;
processing the second client request using the optimal service infrastructure; and
sending the results of the processing of the second client request to the requesting client.

10. The method of claim 1, wherein the first data access request is a request for initial registration of a user from which the client request originated.

11. The method of claim 10, wherein any of the plurality of mobile service infrastructures can operate as the first mobile service infrastructure that handles the initial registration request.

12. The method of claim 1, wherein determining the optimal mobile service infrastructure is based on an attribute of the client making the request.

13. The method of claim 12, wherein the attribute of the client is the organization of the client.

14. The method of claim 12, wherein the attribute of the client is the geographic location of the requesting client.

15. The method of claim 1, wherein the plurality of mobile services infrastructures reside in a plurality of different geographic locations.

16. The method of claim 15, wherein the plurality of mobile services infrastructures residing in a plurality of different geographic locations also maintain a core data infrastructure in each of the plurality of geographic locations.

17. The method of claim 1, wherein the optimal mobile service infrastructure is associated with the nearest mobile service infrastructure.

18. The method of claim 1, further comprising:
receiving a mobile client option bit that identifies whether a mobile user supports a distributed mode or a centralized mode.

19. A computer program product comprising a tangible computer readable medium storing a plurality of instructions for controlling a processor to perform an operation for determining an optimal mobile services infrastructure, the instructions comprising:
a first mobile service infrastructure receiving a first data access request from a first mobile client, wherein the first mobile service infrastructure is one of a plurality of mobile service infrastructures, wherein a mobile service infrastructure is configured to provide communications between a mobile client and a database; and
the first mobile service infrastructure determining an optimal mobile service infrastructure to handle the first data access request based on the requesting client, wherein the optimal mobile service infrastructure is one of the plurality of mobile service infrastructure

20. A database system comprising:
an input interface for receiving a database access request;
a registration mobile services infrastructure, having one or more server components for processing the database access request, wherein the registration mobile services infrastructure is one of a plurality of mobile services infrastructures;
a core data infrastructure, having one or more server components, at least one of which is a database component storing data of interest to the requesting client; and
logic that runs on one or more processors of the one or more server components of the registration mobile services infrastructure and the core data infrastructure, wherein the processors are configured to:
determine an optimal mobile services infrastructure based on the database access request.
